(19) United States
(12) Patent Application Publication
(10) Pub. No.: US 2014/0264078 A1
(43) Pub. Date: Sep. 18, 2014

(54) Radiation Image Read-Out and Cropping System

(71) Applicant: AGFA HEALTHCARE NV, Mortsel (BE)

(72) Inventors: Christine Uytterhoeven, Tisselt (BE); John Gibbs, Borgerhout (BE)

(21) Appl. No.: 13/796,467

(22) Filed: Mar. 12, 2013

(51) Int. Cl. G01T 1/20

(52) U.S. Cl. CPC G01T 1/2014
USPC 250/459.1; 250/458.1

(57) ABSTRACT

A system comprising a read out device for reading a radiation image stored in a photostimulable phosphor screen and for generating a digital signal representation of a read out image wherein the read out device supports a single format and is coupled to a processing unit which is programmed for cropping a region of interest (ROI) in the read out image.

### BACKGROUND OF THE INVENTION

In computed radiography it is nowadays common practice to record a radiation image on a photostimulable phosphor screen by exposing the screen to an image-wise pattern of penetrating radiation such as X-rays.

The latent image stored in the photostimulable phosphor screen is read out by stimulating the phosphor with light having (a) wavelength(s) within the stimulation wavelength range of the phosphor.

The light emitted upon stimulation is then detected and converted into an electronic signal representation of the image.

The electronic signal can then be processed and can be archived, displayed or printed.

Several types of devices for reading radiation images stored in photostimulable phosphor screens, adapted to the needs of hospitals or radiologists are nowadays marketed. Most of these devices are adapted for read out of different formats of photostimulable phosphor screens. Different formats are provided for different kinds of examinations.

However, the fact that a device is adapted to support different formats makes the device expensive. Furthermore the use of different formats demands an extra decision to be made by the operator so as to select the adequate format for a type of examination.

So devices have been developed that are less complex and can only read out a single format.

This implies that the user can only use a single format photostimulable phosphor screen for different kinds of examinations.

If this single format is large compared to the body part that is to be examined, e.g. in case of a radiation image of a small body part such as a hand or a finger, the area outside the body part is commonly covered by x-ray opaque material. The area on the phosphor screen which is effectively used is then rather limited.

### SUMMARY OF THE INVENTION

When such a large format photostimulable phosphor screen is read out, this gives rise to a large data file containing a lot of data which are not relevant for examination because they belong to the shielded area outside of the body part. Large data files occupy a large amount of processing and or storage capacity.

Moreover, the region outside the small region of diagnostic relevance will have high luminance when a hard copy image is generated and displayed on a display screen. The strong light will have a negative impact on the efficiency and accuracy of the diagnosis.

In case of multiple exposures, more than one x-ray image is recorded on different parts of the same photostimulable phosphor screen during more than one successive exposure steps. For example when images of right and left hand are to be examined, these images are often generated on juxtaposed parts of the same phosphor screen, one part of the screen being exposed while the other part is covered with x-ray shielding material. When the stimulable photostimulable phosphor screen is then read out, the digital image signal is composed of the images of the two body parts, as well as of the area surrounding each of the images.

When the exposed objects are small (hands, fingers) the entire read out image comprises a large area which is unimportant for diagnosis.

So, also in case of multiple exposures the above-described problems are encountered.

The present invention relates to a system for reading a radiation image that has been stored in a photostimulable phosphor screen.

It is an object of the present invention to provide a system that overcomes the above-mentioned disadvantages of the prior art.

In general, according to one aspect, the invention features a system comprising a device for reading a radiation image stored in a photostimulable phosphor screen and for generating a digital signal representation of a read out image. The device is adapted to read a single format screen. A processing unit is coupled to the reading device and is programmed for cropping a region of interest (ROI) in said image.

In embodiments, the image is obtained by multiple exposure of said single format photostimulable phosphor screen.

In general, according to another aspect, the invention features a method for processing an image. The method comprises reading a radiation image stored in a photostimulable phosphor screen, generating a digital signal representation of a read out image with a device that is adapted to read a single format screen, and cropping a region of interest (ROI) in said image.

The above and other features of the invention including various novel details of construction and combinations of parts, and other advantages, will now be more particularly described with reference to the accompanying drawings, and pointed out in the claims. It will he understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows the components of a device for reading a radiation image that has been stored in a photostimulable phosphor screen,

FIG. 2 shows a commercially available apparatus for reading out an image that has been stored in a single-format photostimulable phosphor screen,

FIG. 3 is an image originating from multiple exposures of a photostimulable phosphor screen,

FIG. 4 is an image obtained after applying auto-cropping.

### DETAILED DESCRIPTION OF THE PREFERRED EMBODIMENTS

A table top size read out device (Agfa CR 10-X) that is adapted to read a single format photostimulable phosphor screen is shown in FIG. 2. This device has a feeding opening for receiving photostimulable phosphor screens of a single, specific size. The commercial device that is shown is adapted to read out a screen of 35 centimeters (cm)×43 cm at a resolution of 10 pixels/millimeters (mm) (these data are only exemplary and not meant to be limitative for the present invention).

In one embodiment a device of the described kind can be a mobile device that can be transported to the location where a radiographic image is generated and read out. Such a mobile device is e.g. very useful in veterinary applications.

FIG. 1 shows a specific embodiment of a read out device which is adapted for read out of a radiation image that has been stored in a photostimulable phosphor screen.

The apparatus comprises a stimulating light source 2 such as a laser and a galvanometric mirror 4, driven by drive unit 5 arranged to deflect the light emitted by the light source in the fast scan direction.

The apparatus further comprises transport unit (not shown) to transport the screen in the direction of arrow 6 to enable the screen to be two-dimensionally scanned.

Positioned close to but behind the scanning line of the laser beam on the phosphor sheet 1 is a light guide 7 which receives image-wise modulated light emitted from the phosphor sheet but is shielded by shielding unit 8 from direct exposure to the laser beam 3. The light guide comprises individual optical fibers that are bundled at the output end. The output end is positioned close to the entrance of a light distributing means 9 such as a hollow tube-like member with a reflecting inner surface.

The output end of the tube is positioned adjacent to the entrance window of a photo multiplier 10 which produces an electrical signal representative of the light intensity falling on its entrance window. An optical filter (not shown) was placed at the output window of the tube in front of the photomultiplier.

Light originating from a single pixel in the image is transported by at least one of the optical fibers to entrance of the tube and is then further guided by the tube onto the entrance window of the photo-multiplier where the light falling on the entire surface will be integrated and will constitute the input of the light to signal conversion for the generation of the signal presentation of that specific pixel.

The signal generated by the photo multiplier is processed in image processing unit 11.

It is also transmitted to a further processing unit (not shown), also called workstation, coupled to the read out device where it can be subjected to additional processing and can be displayed and/or stored.

The processing unit 11 according to this invention is programmed to perform a cropping operation on the image read out of a phosphor screen without interference of an operator (auto-cropping functionality).

Cropping operates on a read out image to create a new image by selecting a desired portion (region of interest) from the image. Next the cropped region of interest is made to cover the entire image area, in a so-called it to view lay-out, while the parts outside the region of interest are discarded.

An example of a method for automatically detecting a collimated area in an image has been described in European patent application 2 500 864.

When applying the described algorithm a polygon is obtained which delineates the region of interest from the collimated border area (area that was shielded from irradiation).

By means of this polygon a so-called bounding box is calculated that includes this polygon. The bounding box determines the area that will be fit to view.

The described method is a region-based method of recognizing an irradiation field in digital x-ray image. Region-based refers to the fact that candidate irradiation field boundaries are computed out of a segmented map of the image and not directly out of the greyscale image obtained by read out of the irradiated phosphor screen.

The method described in EP 2 500 864 A is a 3-step process. This application relates to PCT/EP2012/03252, filed on 27 Feb. 2013, which claims priority to U.S. Provisional Application No. 61/452,810, filed on Mar. 15, 2011, both of which are incorporated herein by reference in their entirety.

In the first step the image is segmented in multiple regions each comprising pixels which have similar local image characteristics, e.g. by applying a multi-scale watershed method.

The second step is a step of fitting line segments to the region boundaries whereby the line segments are candidate irradiation field boundaries and constitute a segmentation map.

The third step is identifying in the new segmentation map the regions corresponding to irradiation fields using local and/or regional and/or global image characteristics. This is performed by classifying regions in the segmentation map into at least two classes, one class being irradiation field and the other class being collimated region on the basis of at least one of local, regional and global image characteristics.

The segmentation of the image in multiple regions may be improved using image clustering to merge regions which have similar local image characteristics.

In one embodiment the clustering technique is hierarchical clustering with the measure of similarity based on at least one of the median or average greyscale pixel value of a segmented region, the standard deviation of the greyscale pixel values within a segmented region and the position of the segmented region in the image.

A Hough transform may be applied to the boundaries of the segmented regions to fit line segments corresponding with candidate irradiation field boundaries.

The applied Hough transform may be normalized and corrected in a way that the Hough space values of the boundaries of the irradiation fields in the image approximate value 1.0.

In one embodiment only line segments are preserved that have a significant overlap with the boundaries of the clustered regions, are preserved.

Regional characteristics are e.g. computed out of the histograms of local standard deviation of the different segmented regions, for example a distance measurement between said histograms and a histogram of local standard deviation of the total image.

Another example of such a characteristic is a distance measurement between said lust grants and a reference histogram of local standard deviation of only the brightest regions in the image.

Still another example is the cumulative sum of the histogram below a specified histogram abscissa.

Examples of regional characteristics are: the amount of strong edges in the different segment regions, the average greyscale pixel difference between a region of interest and its surroundings in the neighbourhood of the boundaries of the said region of interest.

In one embodiment the binary classification is performed by using a perceptron.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system comprising
a device for reading a radiation image stored in a photostimulable phosphor screen and for generating a digital signal representation of a read out image, said device being adapted to read a single format screen,
a processing unit coupled to said reading device, said processing unit being programmed for cropping a region of interest (ROI) in said image.

2. A system according to claim 1 wherein said image is obtained by multiple exposure of said single format photostimulable phosphor screen.

3. A method for processing an image, comprising
reading a radiation image stored in a photostimulable phosphor screen;
generating a digital signal representation of a read out image with a device that is adapted to read a single format screen, and
cropping a region of interest (ROI) in said image.

4. A method according to claim 3 further comprising obtaining said image by multiple exposure of a single format photostimulable phosphor screen.
